(19) United States
(12) Patent Application Publication
(10) Pub. No.: US 2015/0276367 A1
(43) Pub. Date: Oct. 1, 2015

(54) METAL FRAMING LAYOUT SQUARE AND A METHOD OF USING SAME

(71) Applicants: Michael Lamanna, Massapequa, NY (US); Richard Gross, Massapequa, NY (US)

(72) Inventors: Michael Lamanna, Massapequa, NY (US); Richard Gross, Massapequa, NY (US)

(21) Appl. No.: 14/194,064

(22) Filed: Feb. 28, 2014

Related U.S. Application Data
(60) Provisional application No. 61/857,021, filed on Jul. 22, 2013.

(51) Int. Cl. G01B 3/56; G01B 3/00; G01B 3/04

(52) U.S. Cl. CPC G01B 3/566; G01B 3/04; G01B 3/004

(57) ABSTRACT

A metal framing layout square of substantially flat unitary construction and a method for using the same is provided. The square preferably includes an elongated blade, an elongated slot defined in the blade and parallel to the edges of the blade to provide two additional edges for the marking of measurement scales. The tool provides a tongue joined at a right angle to the blade. The metal framing layout square is preferably used with the layout phase of interior metal framed walls, and is directed to a metal framing layout square for use in constructing compound metal framing systems comprising a plurality of predetermined lengths and widths, and has slots which are to allow a user to readily mark a series of layout marks from a starting point to efficiently complete a set of markings for an entire framing structure with minimal need for secondary measuring devices.

### BACKGROUND OF THE INVENTION

1. Field of the Invention

The present invention relates generally to framing systems used in the construction of buildings, and tools for measurement and marking for metal framing systems that incorporate hollow metal tubing. More specifically, the invention relates to a metal framing layout square comprising a blade and tongue elements with one or both having an elongated slot therein for use in the layout phase of interior metal framed walls.

2. Description of the Related Art

There are many known framing systems used in the construction industry that are typically made of either wood or metal, with wood framing systems being the most common. As is well known, wood framing systems have enjoyed widespread use, and are typically constructed by connecting pieces of wood, such as 2×4's or 2×6's, with nails in a form that creates either the interior or exterior outline of a structure, or both. The major components are typically made of wood, including components which may be referred to in the art as the bottom plate, studs, top plate and roof trusses. With the exception of roof trusses, which utilize miter cuts on the ends of adjacent pieces of wood to accomplish the desired angular relationship between adjacent members, most wood framing systems consist primarily of straight 2×4's nailed together to define the outside and inside areas of the structure and to provide the load bearing support.

Although wood framing systems have enjoyed widespread use, they are subject to several disadvantages. For instance, the process of constructing a wood framing system is relatively slow since all joints within the system are typically connected with several nails. For example, even if the included roof trusses are pre-assembled, it typically takes a framing crew of four people between five and seven working days to frame a 1,500 square foot house. Also, the quality of the workmanship associated with the construction of wood framing is often poor, especially in conjunction with low and moderate priced housing where builder's profit margins are relatively low and building costs are suppressed as much as possible. The primary result of this poor workmanship is typically the lack of squaring the structure frame which adversely affects the installation of other components in the structure. Additional disadvantages associated with wood framing include the flammability of wood, the potential for deterioration due to exposure to weather or insects such as termites or carpenter ants, the reduced strength at angled connections which require a miter cut and attachment with either nails or screws, and the depletion of wood as a natural resource.

Although metal framing systems may represent an improvement relative to wood framing systems with regard to improved strength and reduced deterioration, known metal framing systems are also typically subject to one or more disadvantages. For instance, like a wood framing system, the assembly of a metal framing system may be very time consuming since the metal framing system may require nearly as many metal screws as the nails used in a comparable wood framing system to connect adjacent metal components. Moreover, the screws are generally not as quickly inserted as nails or may be difficult to insert, and therefore the metal framed structure may actually require more time to assemble than a comparable wood framed structure.

Metal framing systems have been used for some time in commercial construction and have recently become more popular in residential construction. Known metal framing systems used in these applications commonly include metal components which are formed as three-sided channels, such as U-channels. For instance, these systems may include vertically extending metal channels, which are inserted into the open side of horizontally extending metal channels used for the bottom and top members of the metal framing system. The joints between the vertically and horizontally extending members are typically secured with numerous fasteners such as screws. Additionally, metal straps are often utilized to secure the vertically extending channel members to one another. Accordingly, the assembly of a metal framing system of this type may be very time consuming due to the requirement to secure the numerous fasteners and metal straps.

Another known metal framing system, which is used to frame a carport, utilizes round hollow tubing with one end of each of the round tubing members being inserted into the hollow end of an adjacent round tubing member. The joint between the two round tubing members may then be stabilized with conventional fasteners. The male portion of each joint may be accomplished by a swaging process to reduce an end portion of the corresponding round tubing member. Although the foregoing carport framing system has been advantageously utilized, use of round metal tubing makes it difficult to insert fasteners into the tubing joints which complicates the assembly of the framing system. Furthermore, in some applications, such as when the carport is placed adjacent to a residential structure, the carport frame may not be viewed as aesthetically appealing.

It is often more advantageous to use either square or rectangular metal tubing in certain applications. However, the connection of adjacent components of square or rectangular metal tubing has been subject to the following problems. Known methods of reducing square and rectangular metal tubing include those which utilize one or more dies. With this form of reduction, one end of the square or rectangular tube is crushed by the force created by various configurations of press equipment, with the size of the reduction being determined by the die design. This method of end reduction of square and rectangular metal tubing is subject to the following disadvantages. In the first instance, the end reduction of the tubing may require several “hits” or applications of the press equipment to achieve the desired reduction, with each application adding to the manufacturing cost. Furthermore, the crushing force of the press equipment may cause excessive and/or non-uniform deformation of the tube end. More specifically, one or more sides of the tubing may become concave, thereby reducing the overall strength of the tube and detracting from the smoothness of the transition between the original shape and the reduced end. In certain instances, the excessive and/or non-uniform deformation may be so severe that the reduced end of the tube is not capable of insertion into a tube of the same size prior to reduction, as intended.

Due to the foregoing problems associated with the use of dies to end reduce square and rectangular tubing, connections of adjacent lengths of like-sized square and rectangular metal tubing has generally been accomplished by inserting a smaller tube, of the same shape, inside two adjacent like-sized pieces of rectangular or square metal tubing, and then securing the joint by fastening each section of the outer tubes to the inner tube. Framing systems of this type have been used to frame carports. The inner tube, as well as the required fasteners, add to the cost of this method of joining adjacent sections of square or rectangular metal tubing. Another disadvantage associated with this type of metal framing system is that the strength of the included joints may be limited to the strength of the required fasteners at each joint.

Carpentry framing squares have been in common use for over a century. Most squares are composed of two legs forming a right angle. The longer leg is generally referred to as the “blade”, with the shorter leg being referred to as the “tongue”. Both the tongue and blade are typically marked with scales along their edges. These scales allow the user to mark desired cutting angles on lumber. However, the use of the scales is somewhat cumbersome since the user must visually align the marks on the scale with the edge of the wall member.

Developed over one hundred years ago, standard carpentry framing squares provide a builder with calculated values for determining basic pieces of information for framing. Standard carpentry framing squares typically comprise two flat, elongated arms—the blade and the tongue—oriented at ninety degrees to one another and bearing incremented scales in inches. These scales enable carpenters to compute rafter lengths and rafter cut angles. The blade scale indicia typically represent the run wherein one foot (i.e., twelve inches) represents the standard base run. The corresponding rise is specified on the opposing tongue as inches of rise per foot of run. A user readily may identify locations for accurate level seat cuts and vertical plumb cuts by laying the square on the side of a beam, aligning the twelve inch mark on the body scale with the edge of the top face of the beam, and aligning with the edge of the beam the tongue scale number representing the ratio of the rise to the span (inches of rise per foot of run). Once the body and tongue are aligned, the builder may mark lines along the edges of the body and tongue respectively to indicate cut lines for seat and plumb cuts.

Some carpentry framing squares comprise various tables imprinted on the blades for use in calculating other construction measurements. Typically, these articles provide rudimentary tables for use with determining rafter lengths, board feet and diagonal brace lengths. For example, a square incorporating a useful table for computing common rafter lengths is known. This table, printed on the front face of the square, provides rafter lengths for the standard roof pitches of one-fourth, one-third and one-half, based on a particular building span. Not only is this table limited to three common pitches, the square provides no information for determining measurements related to hip and valley formation. By comparison, another square incorporating a more robust rafter table containing computations for determining common rafter lengths for rise over run ratios of two-twelfths to eighteen-twelfths and provides tables for determining hip and valley rafter lengths.

Such squares, and others, provide limited information and all require additional complex calculations to determine angles and lengths at which to cut framing members, especially those forming compound joinery. In particular, these standard carpentry squares provide limited tabular information, and the measurement and alignment scales marked on the faces of these tools fail to address a large range of unequal pitches required during the design and building of unequal pitched roofs, for example. Some squares comprise complicated hinge mechanisms in an effort to improve usability; these tools, however, are less reliably “square” and nonetheless still limited to the scant markings on the face of the body and tongue. These existing carpentry squares has provided a wide breadth of precise calculations and alignment indicia requiring little computational effort on the part of the user to measure and cut lengths and angles during the formation of compound joinery.

For example, as shown in FIGS. 1-2, prior art combination framing and speed squares 10, 11 comprises a first substantially planar leg 1 with a second substantially planar leg 2 perpendicularly extending from an end thereof. Both the first and second legs each have a free distal end and inner and outer edges. The intersection of the inner edge of the first and second legs define a pivot point around which the device is rotated when making various cut marks.

A third leg 3 (see FIG. 2) having an outer edge diagonally extends from the first leg 1 to the second leg 2 forming a right triangular opening 4 therebetween. The third leg 3 is attached to the first 1 and second legs 2 at a predetermined distance from their respective distal ends as depicted in FIG. 1 thereby combining the physical features of a carpentry framing square with that of a speed square.

Also, it is know to have the length of the first leg 1 and the second leg 2 of the square to be approximately twenty four inches which allows a user to mark lengths in increments of two feet. Other conventional carpentry framing squares have only one leg is sixteen or twenty four inches. Also as is known, the first leg 1 may be 2 inches wide and the second leg 2 may be 1½ inches wide. However, the dimensions of the first and second legs may be varied to suit a particular application without departing from the concept of the invention, i.e. a combination framing and speed square.

Interior metal framing is mostly done with three different stud and track sizes, which include one and five-eighths inch, two and one-half inches, and three and five-eighths inches. These dimensions generally represent the thickness or depth of a wall minus the wall's sheathing material (e.g., sheetrock, wood, plaster, panels, stretch wall, etc.). In other words, a three and five-eighths inch stud with a single layer of sheetrock on both sides and corner bead equals a five and one-eighth inch thick wall. The combinations of materials create numerous possibilities for the wall thickness, and numerous potential errors. Prior to construction, when laying out wall locations, a installer would use marking paint to mark or color the desired locations for the wall various components. Once a starting point indicator (often a paint marker with survey lines) has been established a user would mark the location of a layout starting point and then continue to make a series of marks using the framing square and then connect the marks again using the framing square (mostly as a straight edge). Such a process requires a significant amount of measuring and movement of the framing square to complete, and must also be performed on both ends of every wall on the particular site. The result is a ‘map’ on the floor that shows the installers exactly what materials are to be used and exactly what locations the materials are to be positioned in order for the walls to be finished.

Furthermore, in addition to the limited information provided to a builder or installer, existing squares are limited for use with either a standard measurement system (e.g., inches) or a metric system. None are universally applicable to both standard and metric units of measurement. Those squares that address metric systems are complex and cumbersome and require substantial additional calculations, which can result in computational errors and irreversibly incorrect cuts in framing members.

A need exists for a metal framing layout square comprising a plurality of predetermined lengths and widths, and has gaps or slots, all of which are to allow a user to readily mark a series of layout marks from a starting point to efficiently complete a set of markings for an entire framing structure.

### SUMMARY OF THE INVENTION

In view of the foregoing needs, the present invention is directed to a simple, cost effective and efficient tool for measuring and marking layouts for metal framing systems for framing at least a portion of a wide variety of structures. Some of such structures include residential homes, commercial buildings, apartment and condominiums, office build-outs, utility buildings, and modular or kiosk structures. The framing systems for use with the present invention utilizes either rectangular or square metal tubing, or a combination thereof, and therefore has several advantages over existing wood framing systems.

The ease of assembling various components of the metal framing systems allows an overall significant reduction in time, and therefore of cost, in framing various structures relative to prior wood framing systems. For instance, the speed of assembly and therefore the reduction in cost associated with the metal framing system is accomplished by interconnecting various components of the framing system by inserting a reduced end portion of one member or component into an adjacent component which is constructed of a like-sized and similarly shaped metal tube. As an example of the time and cost reductions which may be realized using a framing system embodying the principles of the present invention, a 1,500 square foot house may be framed in less than one day using a crew of four people whereas it typically takes a similar sized crew between 5-7 working days to frame a similar structure using wood.

The metal framing layout square according to the present invention solves the problems associated with existing carpentry framing squares. The layout square according to the invention is preferably used with the layout phase of interior metal framed walls, as discussed above, and is directed to a metal framing layout square for use in constructing compound metal framing systems comprising a plurality of predetermined lengths and widths, and has gaps or slots, all of which are to allow a user to readily mark a series of layout marks from a starting point to efficiently complete a set of markings for an entire framing structure.

The present invention further relates to a unitary, multi-purpose tool that has the features and advantages of a framing square and which overcomes the disadvantages of the prior art enumerated above. The device comprises a first elongated substantially planar leg (blade) having a second substantially planar leg (tongue) perpendicularly extending from an end thereof. Preferably, the blade has a plurality of measurement indicia such as one inch calibrations and fractions thereof adjacent its outer edge. The tongue also has a plurality of measurement indicia proximal an inner edge. The first and second legs each have a level indication means such as a bubble level thereon.

The present invention also relates to a framing and layout square of flat unitary construction which provides many advantages in clarity and ease of use to craftsmen or relative novices over prior devices such as carpentry framing squares and various measuring tools. The metal framing layout square is designed to greatly simplify framing and metal framing layout work. It is an improvement over the old-fashioned standard carpentry framing square, providing additional features and greater capabilities. The substantially L-shaped square is provided with an elongated blade attached at a right angle to an elongated tongue. The blade defines a slot which may provide additional edges for measurement scales. Other features of the invention may include tables and scales permanently marked on both sides of the tool to permit easy and quick conversion of values and measurement of angles, lengths and thicknesses.

The metal framing layout square according to the present invention creates a tool that simplifies the layout process, reduces time to do so, decreases mistakes, and increases efficiency. The tool preferably has an exterior length of twenty-four inches for the blade and sixteen inches for the tongue, and will preferably be 16 Gauge to one-eighth inch in thickness. The tool according to the invention may also have dimension lines and numbers stamped on both sides of each of the blade and/or tongue. One difference and improvement over prior carpentry framing squares is in the width and the hollow slots in one or both of the blade and tongue. Preferably, the blade has a dimension of two and one-half inches wide by twenty-four inches long with a five-eighth inch slot that runs down its length at one inch from the outside edge. This slot preferably begins three and five-eighth inches from the outside corner and runs to sixteen inches from the outside corner. Regarding the tongue, preferably it has a dimension of three and five-eighths inches wide by sixteen inches long with a three-fourths inch slot that runs down the length at one and five-eighth inches from the outside edge with one and one-fourth inch remaining on the inside edge. The slot preferably begins two and one-half inches from the outside corner and continues to fourteen and one-half inches from the outside corner, thereby creating a twelve inch slot.

Referring to the layout process, the changes in the metal framing layout square according to the invention make a significant difference in how metal framing layout will be done. The preferred dimensions of the framing square according to the invention are specifically chosen for metal framing layouts. Typical dimensions employed in metal framing layout include: three and five-eighths inch tongue used to scribe for a three and five-eighths inch stud wall; two and one-half inch blade used to scribe for a two and one-half inch stud wall; one and five-eighths inch section of the tongue used to scribe for a one and five-eighths inch stud wall; three-fourths inch slot in the tongue used to scribe the location of three-fourths inch plywood; one and one-fourth inch solid portion of the tongue used to scribe location of two layers of five-eighths inch sheetrock; the side to side location of the slot gives the installer an exact location to begin standing up the metal studs, where the slot begins two and one-half inches from the outside corner and continues until fourteen and one-half inches from the outside corner—for one reason: if you are sheathing a wall with sheetrock, (most walls begin and end with the factory beveled/tapered edge cut off the board, which equals four inches) then the first stud from the corner is set at twelve inches and the studs continue at sixteen inches on center; five-eighths inch slot in the blade used to scribe the location of sheetrock; the side to side location of the five-eighths inch slot is made to end sixteen inches away from the outside corner so the user has an easy way to scribe sixteen inch for stud placement; one inch set back on the five-eighths inch slot used to represent a one inch thick panel; and there will also optionally be dimension lines and numbers stamped on both sides of each of the blade and/or tongue member to enable the user to use the square with more accuracy.

In short, the metal framing layout square according to the preferred embodiment of the present invention is designed specifically for metal framing layouts. A compact or half sized version of this square (shorter in length by one half) may also be provided in accordance with the invention.

Accordingly, the present invention provides a metal framing layout square, which correspond to standard size metal all materials that can quickly and easily measure an indeterminate distance. It is therefore an object of the present invention to provide a combination framing square comprising a plurality of predetermined lengths and widths, and has gaps or slots, all of which are to allow a user to readily mark a series of layout marks from a starting point to efficiently complete a set of markings for an entire framing structure. And with the invention, there would be very little or no need for additional tools or other secondary measuring devices, such as tape measures.

It is another object of the present invention to overcome the shortcomings of the prior art and the more traditional methods and to provide a multi-purpose metal framing square which executes a variety of layout and construction tasks with the minimum amount of manipulation of the tool.

It is yet another object of the present invention to provide a metal framing layout square having elongated slots therein.

It is still another object of the present invention to provide a metal framing layout square which has integral level indicating means thereon.

It is a further object to provide a tool of a size which enables it to be readily portable and quickly accessible.

It is yet another object of the present invention to provide a tool which can locate marks for the layout of wall plates for studs, corners, T-posts, and the like with the minimum amount of manipulation, measuring, or moving of the tool.

It is still another object of the present invention to provide a tool which can by the alignment of one number quickly mark plumb cuts.

It is a further object to provide a tool which can be used to scribe parallel lines at various distances from the edges of frame pieces and the like.

It is yet another object of the present invention to provide a tool which has indicia to quickly locate the tool for the marking of 2×4 and 2×6 wall plates.

It is still another object of the present invention to provide a tool with measurement indicia on multiple edges which allow it to perform a variety of layout and measurement tasks.

The above and other aspects, features and advantages of the present invention will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention. For a more complete understanding of the present invention, reference is now made to the following drawings in which:

FIG. 1 shows a plan view of a first prior art carpentry framing square;

FIG. 2 shows a plan view of second prior art carpentry framing square;

FIG. 3 shows a plan view of the preferred embodiment of the metal framing layout square according to the invention showing a pair of elongated apertures;

FIG. 4 shows a plan view of an alternative embodiment of the metal framing layout square according to the invention showing an elongated aperture and further showing measurement and marking indicia;

FIG. 5 shows a perspective view of the metal framing layout square according to the invention shown in FIG. 4;

FIG. 6 shows a perspective view of the metal framing layout square according to the invention shown in FIG. 3; and

FIG. 7 shows a plan view of yet another alternative embodiment of the metal framing layout square according to the invention.

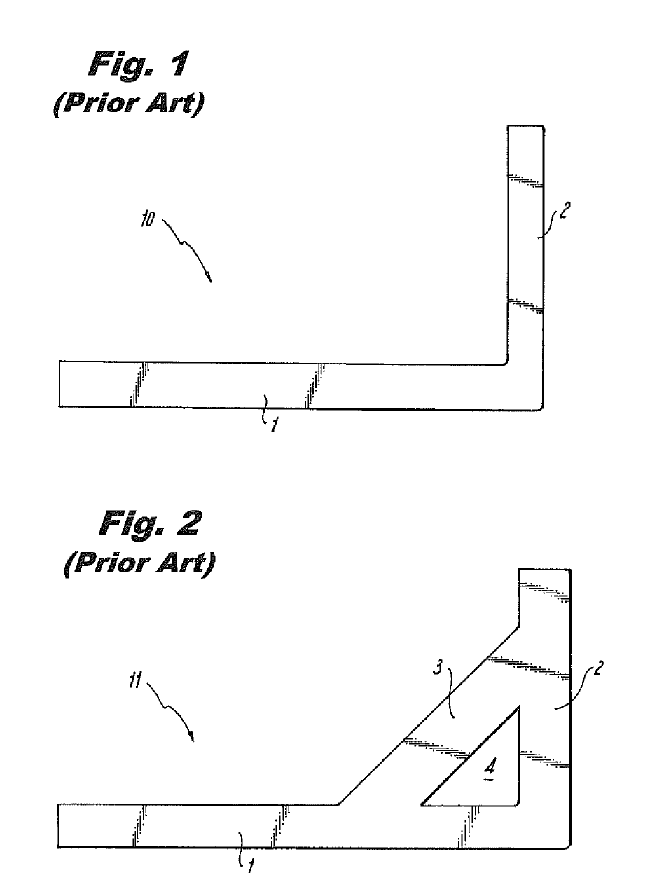

### DETAILED DESCRIPTION OF THE PREFERRED EMBODIMENTS

As required, a detailed illustrative embodiment of the present invention is disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the invention in any manner.

The framing tool according to the invention may be used with a framing system used to frame either an exterior or an interior wall for a wide variety of structures. The framing system may be attached to a concrete support structure which may comprise a concrete slab or a portion of a poured concrete foundation. Alternatively, the framing system may be attached to other conventional foundation or support structures. As yet another alternative, in certain applications, the framing system may rest upon a ground surface. Such a framing system may include a base attached to a concrete support structure by conventional means as subsequently discussed in greater detail. The base is preferably made from either rectangular metal tubing or square metal tubing but may alternatively be made from other metal structures such as metal plates, metal channel sections, and angled metal sections. Additionally, the base may be made as either a unitary or one piece construction, or alternatively may be made from a plurality of the foregoing metal components, such as rectangular or square metal tubing, which are attached to one another.

As used herein, the term “rectangular metal tubing” refers to hollow metal tubing having a substantially rectangular cross-sectional shape and the term “square metal tubing” refers to hollow metal tubing having a substantially square cross-sectional shape. The rectangular and square metal tubing incorporated in the various embodiments of the framing systems may be made of steel or aluminum or any other metal or metal alloy which is suitable for use in constructing a system for use in framing a wide variety of structures including, but not limited to those mentioned previously. Such framing systems further include lower connecting members which are preferably made from either rectangular or square metal tubing and are attached to the base by conventional means, such as welding. The lower connecting members are spaced apart from one another along the base, with the particular spacing depending upon the application of system. For instance, if the framing system is used to frame the wall of a residential structure, the lower connecting members may be advantageously spaced either 16 or 24 inches from one another due to the common use of this spacing in wood framed residential structures. However, it should be understood that other spacings may be utilized in residential home applications.

Such framing systems may also include a plurality of upwardly extending support members, which may be referred to as studs depending upon the particular application of system. Each of the support members is made from either a rectangular metal tube or a square metal tube and is interconnected to one of the lower connecting members via one of a plurality of lower joints. The cross-sectional shape of each support member must match the cross-sectional shape of the corresponding or interconnected one of the lower connecting members. Accordingly, if a particular lower connecting member is made from a rectangular metal tube, then the interconnected one of the support members must also be made from a rectangular metal tube. Similarly, if a particular lower connecting member is made from a square metal tube, then the interconnected one of the support members must also be made from a square metal tube. The support members extend upwardly from the lower connecting members and, in one preferred embodiment, are substantially vertically extending.

Further, such framing systems may further include an upper member which is made from at least one rectangular or square metal tube. The upper member may be made from a single rectangular metal tube, but alternatively may be constructed from a plurality of rectangular metal tubes which may be attached to one another. In other configurations, when the support members are made from square metal tubes, the upper member may be made from either a single square metal tube or a plurality of square metal tubes. In still other configurations the upper member may be made of other metal components such as metal plates, metal channel sections, and angled metal sections. A plurality of upper connecting members which are attached to and extend downwardly from the upper member may be provided. The upper connecting members are made from either rectangular or square metal tubes, with the chosen configuration depending upon the shape of the corresponding support member and lower connecting member. For instance, if both the lower connecting member and support member are made from rectangular metal tubing, then the upper connecting member must also be metal tubing. The upper connecting members are attached to the upper member by conventional means, such as welding. Each of the support members is interconnected to one of the upper connecting members via one of a plurality of upper joints. Each of the upper connecting members is positioned on the upper member so that it is aligned with one of the lower connecting members, while each of the studs extends between one of the lower connecting members and the aligned upper connecting members. A process such as a roll reduction process may be used to form reduced end portions of each support. As used herein, the term “roll reduction process” is intended to refer to reducing an end portion of either a square or rectangular metal tube by inserting the tube into a tool which incorporates a plurality of rollers which are configured and arranged to achieve the desired end reduction in the tube. More specifically, the roll reduction process is intended to achieve the desired end reduction in either a square or rectangular metal tube by utilizing the proper tool.

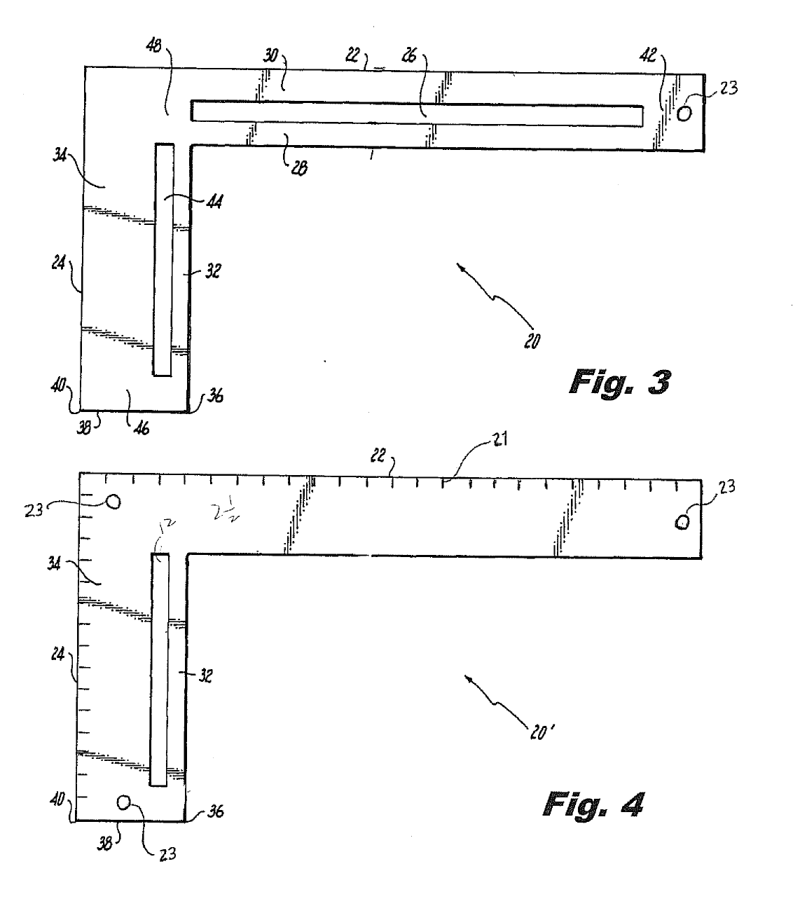

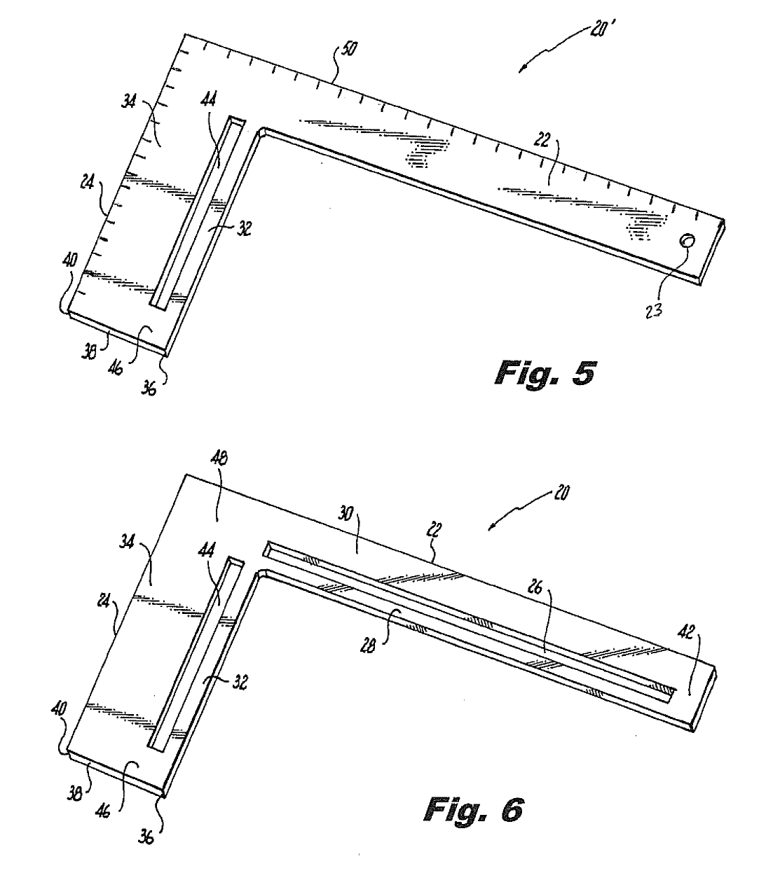

Framing squares, such as the square according to the present invention, are typically used to provide a layout for framing systems and are provided with a base unit of measurement, e.g. inches or millimeters, and provide limited tabulated information for use in calculating lengths, distances, and angles at which to cut framing members. The present invention is a tool that provides universal applicability for use in building both simple and complex structures according to metric and standard/imperial measurement systems. The present invention provides tabulated calculations aligned and indicia that enable construction of equal and complex unequal pitch framing members without necessitating the execution of complex trigonometric calculations. As indicated in FIGS. 4-5, in one embodiment, the front face of the square 20′ preferably comprises measuring indicia. In another embodiment, the square 20′ may include an informational table that provides commonly tabulated calculations for use in applying the square during the framing layout process and construction.

Referring to FIGS. 3 and 6, shown are plan and perspective views of the metal framing layout square 20 according to the preferred embodiment of the present invention having an elongated slots 26, 44 in one or both of the blade 22 and tongue 24 members. As depicted in FIGS. 3 and 6, one face of the framing and layout square 20 embodying the present invention is shown. As may be seen from this view, the square 20 is preferably of unitary construction, and is preferably fabricated of 16-Gauge aluminum alloy with any and all markings engraved thereon, as desired. The main components of framing and layout square 20 are blade 22 and tongue 24. Blade 22 and tongue 24 are disposed at right angles to each other as shown in this and succeeding views. Blade 22 preferably comprises an elongated slot 26 located between and parallel to the blade's inside region 28 and outside region 30. As shown in this embodiment, blade 22 is twenty-four inches in length and two and one half inches in width. Extending from one end of blade 22 at a right angle thereto is located tongue 24 having parallel longitudinal edges 32 and 34. Region 32 extends thirteen and one-half inches from region 28 of the blade 22 to index point 36 (from the intersection point to point 36 is a total of thirteen and one-half inches, and the slot long dimension is twelve inches in length). A terminal edge 38 extends from an index point 36 to a point 40, which is the intersection of terminal edge 38 and the tongue's outside region 34. Terminal edge 38 may be disposed at any angle with respect to outside region 34. Additionally, point 40 may be rounded for safety reasons.

Turning to FIGS. 4-5, the blade 22 or the tongue 24 may optionally have distance marking indicia 21 imprinted or engraved thereon, and extending the length or a portion thereof of blade 22 or tongue 24. In the present embodiment, distance marking indicia 21 are formed on both the first and second planar surfaces of the blade 22 or tongue 24 and may be in metric or in U.S. standard dimensions in a variety of increments and with numerals to indicate each successive increment.

The measurement and marking tool 20/20′ in accordance with this invention may further include a scribe bar located parallel to a side edge and spaced apart inwardly therefrom, for example a distance of about five eighths of an inch. The scribe bar may be bounded by parallel scribing edges, each having indentations corresponding to distance marking indicia formed along the side edge. The measurement and marking tool 20/20′ in accordance with this invention may also include elongated apertures 26/44 bounded by parallel straight edges 28/30 and 32/34. These apertures are preferably perpendicular to one another on the square 20/20′.

The twenty-four-inch blade 22 may also be described as comprising two parallel blades, outside blade 30 and inside blade 28, both of which terminate in common blade terminal 48, as shown. The width of inside blade 28 is preferably seven-eights inch such that slot 26 is preferably five-eighths inch, note that alternatively the width of inside blade 28 is about one and seven-eighths inch, as will be understood by those of skill in the art. Slot 26 has a width of five-eighths inch, so the distance from the inward-facing edge of inside blade 28 to the outward-facing edge of blade 30 is one and five-eights inch so that the total width of the blade two and one-half inches.

The tool preferably has an exterior length of twenty-four inches for the blade 22 and sixteen inches for the tongue 24, and will be 16-Gauge to one-eighth inch in thickness. The tool according to the invention may also have dimension lines and numbers stamped on both sides of each of the blade 22 and/or tongue 24. One difference and improvement over prior framing squares is in the width and the hollow slots in one or both of the blade 22 and tongue 24. Preferably, the blade 22 has a dimension of two and one-half inches wide by twenty-four inches long with a five-eighth inch slot 26 that runs down its length at one inch from the outside edge 30. This slot preferably begins three and five-eighth inches from the outside corner and runs to sixteen inches from the outside corner. Regarding the tongue, preferably it has a dimension of three and five-eighth inches wide by sixteen inches long with a three-fourths inch slot that runs down the length at one and five-eighth inches from the outside edge with one and one-fourth inches remaining on the inside edge. The slot preferably begins two and one-half inches from the outside corner and continues to fourteen and one-half inches from the outside corner, thereby creating a twelve inch slot.

Turning next to FIGS. 4-5, shown are plan and perspective views of the metal framing layout square 20′ according to an alternate embodiment of the present invention having an elongated slot 44 in tongue member 24. As depicted in FIGS. 4-5, one face of the framing and layout square 20′ embodying the present invention is shown. As may be seen from this view, the square 20′ is preferably of unitary construction, and is preferably fabricated of 16-Gauge aluminum alloy with any and all markings engraved thereon, as desired. The main components of framing and layout square 20′ are blade 22 and tongue 24 members. Blade 22 and tongue 24 members are disposed at right angles to each other as shown in this and succeeding views. Blade 22 defines an elongated leg that is twenty-four inches in length and two and one half inches in width. Extending from one end of blade 22 at a right angle thereto is located tongue 24 having parallel longitudinal edges 32 and 34. Tongue 24 defines an elongated slot 44 located between and parallel to the tongue's edges 32 and 34. Edge 32 extends thirteen and one-half inches from edge 28 of the blade 22 to index point 36. A terminal edge 38 extends from an index point 36 to a point 40, which is the intersection of terminal edge 38 and the tongue's outside edge 34. Terminal edge 38 may be disposed at any angle with respect to outside edge 34. Point 40 may be rounded for safety reasons.

The twenty-four-inch blade 22 may also be described as comprising two parallel blades, outside blade 30 and inside blade 28 (see e.g., FIG. 3), both of which terminate in common blade terminal 42, as shown. The width of outside blade 30 is preferably one inch and the width of slot 26 is preferably five eights, as will be understood by those of skill in the art. Slot 26 has a width of five-eighths inch, so the distance from the inward-facing edge of inside blade 28 to the outward-facing edge of blade 30 is two and one-half inches.

The tool preferably has an exterior length of twenty-four inches for the blade 22 and sixteen inches for the tongue 24, and will be 16-Gauge to one-eighth inch in thickness. The tool according to the invention may also have dimension lines and numbers stamped on both sides of each of the blade 22 and/or tongue 24. One difference and improvement over prior framing squares is in the width and the hollow slots in one or both of the blade 22 and tongue 24. Preferably, the blade 22 has a dimension of two and one-half inches wide by twenty-four inches long with a five-eighth inch slot 26 that runs down its length at one inch from the outside edge 30. This slot preferably begins three and five-eighth inches from the outside corner and runs to sixteen inches from the outside corner. Regarding the tongue, preferably it has a dimension of three and five-eighth inches wide by sixteen inches long with a three-fourths inch slot that runs down the length at one and five-eighth inches from the outside edge with one and one-fourth inches remaining on the inside edge. The slot preferably begins two and one-half inches from the outside corner and continues to fourteen and one-half inches from the outside corner, thereby creating a twelve inch slot.

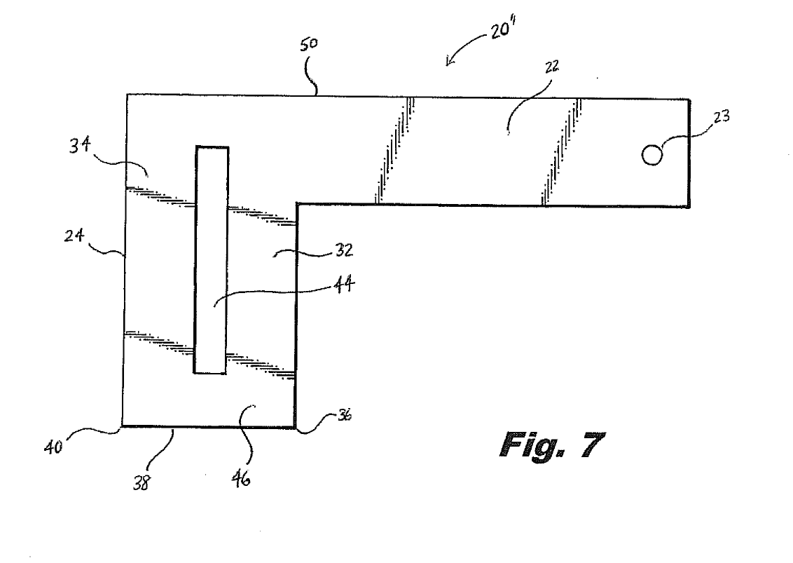

Turning next to FIG. 7, shown is a plan view of yet another alternative embodiment of the metal framing layout square 20″ in accordance with the invention. In particular, as shown, the metal framing layout square 20″ according to the alternate embodiment of the present invention having an elongated slot 44 in tongue member 24. As depicted above in FIGS. 4-5, one face of the framing and layout square 20″ embodying the present invention is shown. As may be seen from this view, the square 20″ is preferably of unitary construction, and is preferably fabricated of 16-Gauge aluminum alloy with any and all markings engraved thereon, as desired. The main components of framing and layout square 20′ are blade 22 and tongue 24 members. Blade 22 and tongue 24 members are disposed at right angles to each other as shown in this and succeeding views. Blade 22 defines an elongated leg that is twenty-four inches in length and two and one half inches in width. Extending from one end of blade 22 at a right angle thereto is located tongue 24 having parallel longitudinal edges 32 and 34. Tongue 24 defines an elongated slot 44 located between and parallel to the tongue's edges 32 and 34. Edge 32 extends twelve inches from edge 28 of the blade 22 to index point 36. A terminal edge 38 extends from an index point 36 to a point 40, which is the intersection of terminal edge 38 and the tongue's outside edge 34. Terminal edge 38 may be disposed at any angle with respect to outside edge 34. Point 40 may be rounded for safety reasons.

The preferred dimensions of the framing square according to the invention are specifically chosen for metal framing layouts. Preferable dimensions employed in metal framing layout include, for example: three and five-eighths inch tongue used to scribe for a three and five-eighths inch stud wall; two and one-half inch blade used to scribe for a two and one-half inch stud wall; one and five-eighths inch section of the tongue used to scribe for a one and five-eighths inch stud wall; three-fourths inch slot in the tongue used to scribe the location of three-fourths inch plywood; one and one-fourth inch solid portion of the tongue used to scribe location of two layers of five-eighths inch sheetrock; the side to side location of the slot gives the installer an exact location to begin standing up the metal studs, where the slot begins two and one-half inches from the outside corner and continues until fourteen and one-half inches from the outside corner—for one reasons: if you are sheathing a wall with sheetrock, (most walls begin and end with the factory beveled/tapered edge cut off the board, which equals four inches) then the first stud from the corner is set at twelve inches and the studs continue at sixteen inches on center; five-eighths inch slot in the blade used to scribe the location of sheetrock; the side to side location of the five-eighths inch slot is made to end sixteen inches away from the outside corner so the user has an easy way to scribe sixteen inch for stud placement; one inch set back on the five-eighths inch slot used to represent a one inch thick panel; and there will also optionally be dimension lines and numbers stamped on both sides of each of the blade and/or tongue member to enable the user to use the square with more accuracy.

In short, preferred dimensions of the framing square according to the invention may include: (1) three and five-eighths inch (3⅝″) for tongue 24; (2) two and one-half inch (2½″) for blade 22; (3) one and five-eighths inch (1⅝″) for outer section 34 of the tongue 24; (4) three-fourths inch (¾″) for slot 44 in the tongue 24; (5) one and one-fourth inch (1¼″) for inner section 32 of the tongue 24; (6) the side to side location of the slot 44 where the slot begins two and one-half (2½″) from the outside corner and continues until fourteen and one-half (14½″) (but may be 12″) from the outside corner; (7) five-eighths inch (⅝″) for slot 26 in the blade 22; (8) the side to side location of the five-eighths inch (⅝″) slot 26 is made to end sixteen inches (16″) away from the outside corner; (9) one inch (1″) set back on the five-eighths inch (⅝″) slot 26; and (10) optionally blade 22 and tongue 24 may have dimension lines and numbers stamped, printed, or otherwise placed on both sides (see FIGS. 4-5) to enable the user to use the square with more accuracy. Preferably, the blade and tongue members of the metal framing layout square of the invention are manufactured with anodized aluminum, plastic or a similar lightweight, corrosion resistant material. The shape, size and color of the distal measuring device may be varied and it may be manufactured using any number of suitable materials.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. An apparatus for a metal framing layout square for use in marking a layout pattern for construction of metal framing systems, said apparatus comprising:
a blade region having substantially parallel interior rectilinear and an exterior rectilinear edges; and
a tongue region having an interior rectilinear edge and an exterior rectilinear edge, said tongue region further having an elongated slot arranged parallel to and disposed between said interior and exterior edges of said tongue region, said slot being of sufficient width to provide a sight opening for aligning an edge of a metal framing member;
wherein said blade is disposed coplanar and perpendicular with said tongues;
wherein said slot is configured so as to provide first and second measurement edges disposed at either side thereof; and
wherein a face of said tongue region includes graphic indicia relating to a plurality of measurements to aid in the use of said apparatus.

2. The apparatus according to claim 1, wherein said blade region includes a linear measurement scale defined thereon.

3. The apparatus according to claim 1, wherein said tongue region includes a linear measurement scale defined thereon.

4. The apparatus according to claim 1, wherein said blade region is configured with a width of two and one-half inches.

5. The apparatus according to claim 1, wherein said blade region is configured with a length of twenty-four inches.

6. The apparatus according to claim 1, wherein said tongue region is configured with a width of three and five-eighth inches.

7. The apparatus according to claim 1, wherein said tongue region is configured with a length of sixteen inches.

8. The apparatus according to claim 1, wherein said elongated slot of said tongue region is configured with a width of three-fourths inch.

9. The apparatus according to claim 1, wherein a face of said blade region includes graphic indicia relating to a plurality of measurements to aid in the use of said apparatus.

10. The apparatus according to claim 1, wherein an interior rectilinear edge of said elongated slot located one and one-fourth inches from said interior rectilinear edge of said blade region.

11. The apparatus according to claim 1, wherein said blade region further comprises an elongated slot arranged parallel to and disposed between said interior and exterior edges of said blade region, and
wherein said slot is of sufficient width to provide a sight opening for aligning an edge of a metal framing member.

12. The apparatus according to claim 11, wherein said slot of said blade region is configured with a width of five-eighth inches.

13. The apparatus according to claim 1, wherein said graphic indicia is selected from the group consisting of metric measurements, standard measurements, mathematical calculations, instructions, standard framing dimensions, and tabulated calculations.
